(19) United States
(12) Patent Application Publication
(10) Pub. No.: US 2006/0121954 A1
(43) Pub. Date: Jun. 8, 2006

(54) Power consumption management for the playback of multimedia messages

(75) Inventor: Von A. Mock, Boynton Beach, FL (US)

Correspondence Address: FLEIT, KAIN, GIBBONS, GUTMAN, BONGINI;& BIANCO P.L., 551 N.W. 77TH STREET, SUITE 111, BOCA RATON, FL, 33487, US

(73) Assignee: MOTOROLA, INC., SCHAUMBURG, IL (US)

(21) Appl. No.: 11/003,189

(22) Filed: Dec. 3, 2004

(51) Int. Cl. H04B 1/38

(52) U.S. Cl. 455/574

(57) ABSTRACT

A method, computer program, and a wireless device (104) dynamically manages available power for the wireless device (104) based on energy units required by a multimedia message. The wireless device (104) receives a multimedia message that has at least one of its media components corresponding to an energy profile (408). The wireless device (104) determines a current state of an energy source of the wireless device (104). The wireless device (104) inhibits playback of the at least one media component corresponding to the energy profile (408) if the determined current state of the energy source is below a predefined energy threshold.

### FIELD OF THE INVENTION

The present invention generally relates to the field of energy consumption management for electronic devices, and more particularly relates to energy consumption management for playback of multimedia messages by electronic devices including wireless communication devices such as cellular phones or smart phones.

### BACKGROUND OF THE INVENTION

Wireless communication devices have now become integrated into the daily lives of the general public. These devices are being used by a large range of users for a wide variety of applications. As demand for newer technologies increases, wireless communication devices continue to expand in function and features. Camera, video, and audio capture, and the ability to view the data produced by these functions are just a few of the capabilities currently being integrated into cellular phones and other wireless communication devices. Many of these capabilities consume large quantities of power from the energy source, typically a rechargeable battery, found in many wireless communication devices such as cell phones. The life of a battery is very important to users of portable devices, and including users of wireless communication devices. A short battery life can be detrimental to the commercial viability of a product such as a wireless communication device. Unfortunately, advancements in energy source technology have not been able to keep pace with additional new features that continue to additionally drain the energy source on the wireless communication devices. This is an ongoing problem.

Another problem is that frequently a user is unaware that the energy level of the wireless communication device has reached a critically low level, preventing basic functions such as making an outgoing call or receiving an incoming call. A user may continue to use the device in a way that significantly drains the battery, such as may be possible while viewing a complex multimedia message, and without realizing the consequences. Thus, for example, a user will be unable to make an outgoing call, or receive an incoming call, in an emergency situation. This can be a very serious problem in an emergency situation.

Yet another problem is that generally disabling the ability to view and access multimedia messages, files, or the like, such as when the energy level is determined to be low can result in poor power management while at times needlessly preventing the user from accessing valuable multimedia message information. A blanket restriction of access to all multimedia messages to help reduce energy consumption unnecessarily limits the user's interaction with the wireless device.

Therefore a need exists to overcome the problems with the prior art as discussed above.

### SUMMARY OF THE INVENTION

Briefly, in accordance with the present invention, disclosed is a method and computer program product on an electronic device for dynamically managing available power for the electronic device such as a wireless communication device, a personal digital assistant (PDA), and/or a cellular telephone, based on energy consumption units required by a multimedia message. The method comprises receiving a multimedia message that has at least one of its media components corresponding to an energy profile. The method further comprises determining a current state of an energy source of an electronic device. The method further comprises inhibiting playback of the at least one media component corresponding to the energy profile. Playback of the at least one media component is inhibited if the determined current state of the energy source is below a predefined energy threshold.

In another exemplary embodiment of the present invention, an electronic device dynamically manages available power for the electronic device based on energy consumption units required by a multimedia message. The electronic device comprises an energy source and a receiver for receiving wireless communications. The wireless communications can include at least one multimedia message including at least one media component that corresponds to an energy profile. The electronic device further comprises a memory for storing the received multimedia message and a device controller that is electrically coupled to the memory. The device controller determines a current state of the energy source and inhibits playback of the at least one media component if the current state of the energy source is below a predefined energy threshold. The electronic device further comprises an interface that is electrically coupled to the device controller.

In yet another exemplary embodiment of the present invention, a computer readable medium includes computer instructions for dynamically managing available power for an electronic device based on energy units required by a multimedia message is disclosed. The computer instructions comprise instructions for receiving a multimedia message that has at least one of its media components corresponding to an energy profile. The computer instructions further comprise instructions for determining a current state of an energy source of an electronic device. The computer instructions further comprise instructions for inhibiting playback of the at least one media component corresponding to the energy profile. Playback of the at least one media component is inhibited if the determined current state of the energy source is below a predefined energy threshold.

An advantage of the foregoing embodiments of the present invention is that a blanket restriction on viewing multimedia messages to conserve energy is avoided. This results in a more efficient management of available energy and provides the user with increased interactivity with the electronic device when the energy level is low.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram illustrating a wireless communication system according to an embodiment of the present invention.

FIG. 2 is a block diagram illustrating a wireless device for a wireless communication system according to an embodiment of the present invention.

FIG. 3 is a block diagram illustrating a more detailed view of memory and storage for the wireless device of FIG. 2.

FIG. 4 illustrates an exemplary energy consumption record according to an embodiment of the present invention.

FIG. 5 is an operational flow diagram illustrating the process of inhibiting playback of one or more media components of a multimedia message.

FIG. 6 is an operational flow diagram illustrating the process of notifying a user when playback of a multimedia message is inhibited.

FIG. 7 is an operational flow diagram illustrating the process of substituting a new media component for a media component whose playback is inhibited.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system. The terms “playback” and “play”, as used herein, are defined as encompassing the viewing, playing, listening to, or sensing of all types of media and media components.

The present invention, according to an embodiment, overcomes problems with the prior art by providing dynamic management of energy consumption by media components in a multimedia message.

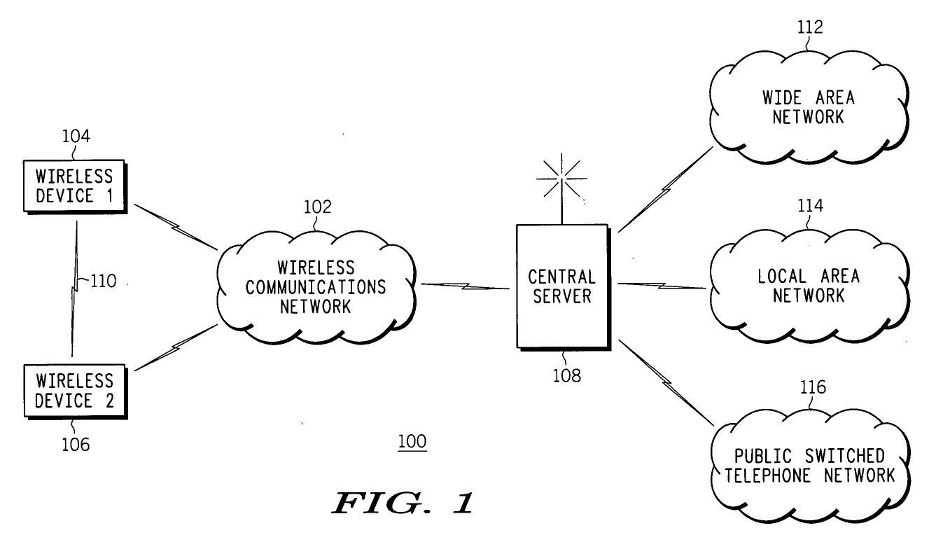

According to an embodiment of the present invention, as shown in FIG. 1, an exemplary wireless communications system 100 is illustrated. FIG. 1 shows a wireless communications network 102, that connects wireless devices 104, 106 with a central server 108. The wireless network 102 comprises a mobile phone network, a mobile text messaging device network, a pager network, or the like. Further, the communications standard of the wireless network 102 of FIG. 1 comprises Code Division Multiple Access (CDMA), Time Division Multiple Access (TDMA), Global System for Mobile Communications (GSM), General Packet Radio Service (GPRS), Frequency Division Multiple Access (FDMA) or the like. Additionally, the wireless communications network 102 also comprises text messaging standards, for example, Short Message Service (SMS), Enhanced Messaging Service (EMS), Multimedia Messaging Service (MMS), or the like.

The wireless network 102 supports any number of wireless devices 104, 106 which includes support for mobile telephones, smart phones, text messaging devices, handheld computers, pagers, beepers, or the like. A smart phone is a combination of 1) a pocket PC, handheld PC, palm top PC, or Personal Digital Assistant (PDA), and 2) a mobile telephone. More generally, a smartphone can be a mobile telephone that has additional application processing capabilities.

Additionally, the wireless devices 104, 106 also include a local wireless link 110 that allows the wireless devices 104, 106 to directly communicate with each other, or with other devices, and without using the wireless network 102. The local wireless link 110, for example, is provided by Integrated Enhanced Digital Network (iDEN), Bluetooth, Infrared Data Access (IrDA) technologies or the like. The wireless devices 104, 106 are described in greater detail below.

The central server 108 maintains and processes information for all wireless devices 104, 106 communicating on the wireless network 102. Additionally, the central server 108, in this example, communicatively couples the electronic devices 104, 106 to a wide area network 112, a local area network 114, and a public switched telephone network 116 through the wireless communications network 102. Each of these networks 112, 114, 116 has the capability of sending data, for example, a multimedia text message to the wireless devices 104, 106.

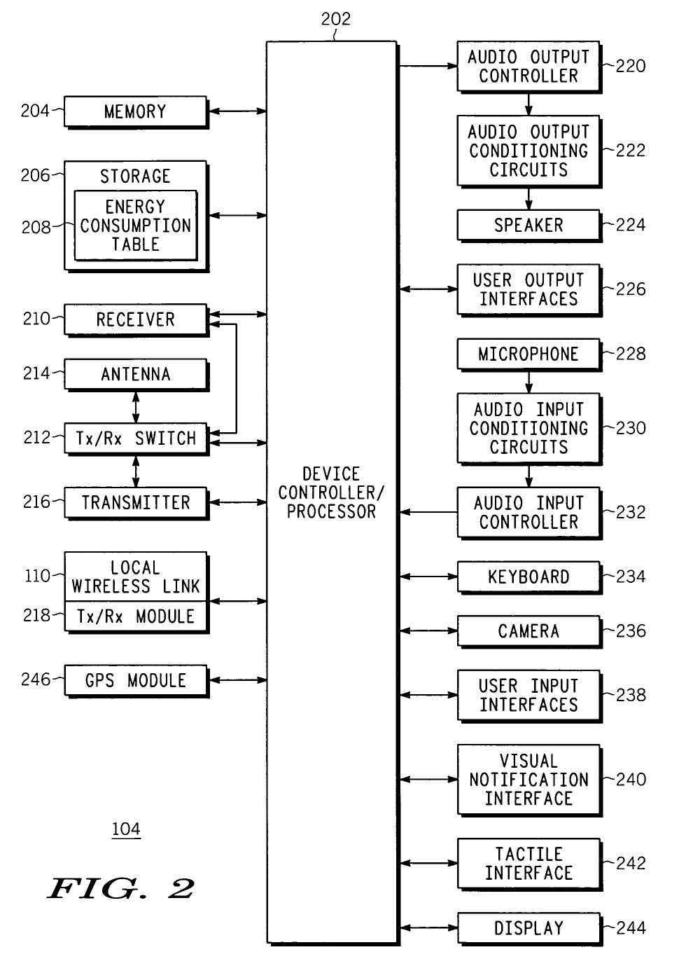

FIG. 2 illustrates a wireless device 104 for a wireless communication system 100. In one embodiment of the present invention, the wireless device 104 comprises a two-way radio capable of receiving and transmitting radio frequency signals over a communication channel under a communications protocol such as CDMA, FDMA, TDMA, GPRS, GSM or the like.

The wireless device 104 operates under the control of a device controller/processor 202, that switches the wireless device 104 between receive and transmit modes. In receive mode, the device controller 202 electrically couples an antenna 214 through a transmit/receive switch 212 to a receiver 210. The receiver 210 decodes the received signals and provides those decoded signals to the device controller 202. In transmit mode, the device controller 202 electrically couples the antenna 214, through the transmit/receive switch 212, to a transmitter 216. The device controller 202 operates the transmitter 216 and receiver 210 according to instructions stored in the memory 204. These instructions include a neighbor cell measurement-scheduling algorithm. Additionally, the memory 204 stores data from a received multimedia message for playback of the message to a user of the wireless device 104.

FIG. 2 also includes a non-volatile storage memory module 206 for storing information that may be used during the overall process of the present invention. In one embodiment of the present invention, an energy consumption table 208 resides in the storage memory module 206. The energy consumption table 208 will be discussed in greater detail below. Additionally, a multimedia message (not shown) received by the wireless device 104 can be stored in the storage memory module 206 for future playback.

An exemplary local wireless link 110 comprises iDEN, Bluetooth, IrDA technologies or the like. The local wireless link 110 also includes a local wireless link transmit/receive module 218 that allows the wireless device 104 to directly communicate with another device, such as another wireless device 106. For example, the wireless device 104 can receive a multimedia message directly from another wireless device 106 without having to communicate through the wireless communications network 102. (See FIG. 1).

The wireless device 104 of FIG. 2 further includes an audio output controller 220 that receives decoded audio output signals, such as from the receiver 210 or the local wireless link transmit/receive module 218. The audio controller 220 sends the received decoded audio signals to the audio output conditioning circuits 222 that perform various conditioning functions. For example, the audio output conditioning circuits may reduce noise or amplify the signal. A speaker 224 receives the conditioned audio signals and allows audio output for listening by a user. The wireless device 104 further includes additional user output interfaces 226, for example, a head phone jack (not shown) or a hands-free speaker (not shown).

The wireless device 104 also includes a microphone 228 for allowing a user to input audio signals into the wireless device 104. Sound waves are received by the microphone 228 and are converted into an electrical audio signal. Audio input conditioning circuits 230 receive the audio signal and perform various conditioning functions on the audio signal, for example, noise reduction. An audio input controller 232 receives the conditioned audio signal and sends the signal to the device controller 202. The device controller 202 then can route the audio signals to a destination such as to the transmitter 216 for transmitting into the wireless communication system 100, or such as to memory 206 for storage of the audio signals.

The wireless device 104 also comprises a keyboard 234, and other user input devices such as buttons and switches, for allowing a user to enter user input information into the wireless device 104. The wireless device 104 further comprises a camera 236 for allowing a user to capture still images or video images into memory 204. Furthermore, the wireless device includes additional user input interfaces 238, for example, touch screen technology (not shown), a joystick (not shown), or a scroll wheel (not shown).

A visual notification (or indication) interface 240 is also included on the electronic device 104 for rendering a visual notification (or visual indication), for example, a sequence of colored lights on the display, to the user of the electronic device 104. For example, a received multimedia message may include a sequence of colored lights to be displayed to the user as part of the message. Alternatively, the visual notification interface 240 can be used as an alert by displaying a sequence of colored lights on the display when the electronic device 104 receives a multimedia message.

The electronic device 104 also includes a tactile interface 242 for delivering a vibrating media component, tactile alert, or the like. For example, a multimedia message received by the electronic device 104, may include a video media component that provides a vibration during playback of the multimedia message. The tactile interface 242 allows this vibration to occur, for example, through a vibrating motor or the like.

The electronic device 104 also includes a display 244 for displaying information to the user of the wireless device 104 and an optional Global Positioning System (GPS) module 246. The optional GPS module determines the location and/or velocity information of the wireless device 104. This module 246 uses the GPS satellite system to determine the location and/or velocity of the wireless device 246. Alternative to the GPS module 246, the wireless device 104 may include alternative modules for determining the location and/or velocity of wireless device 104, for example, using cell tower triangulation and assisted GPS.

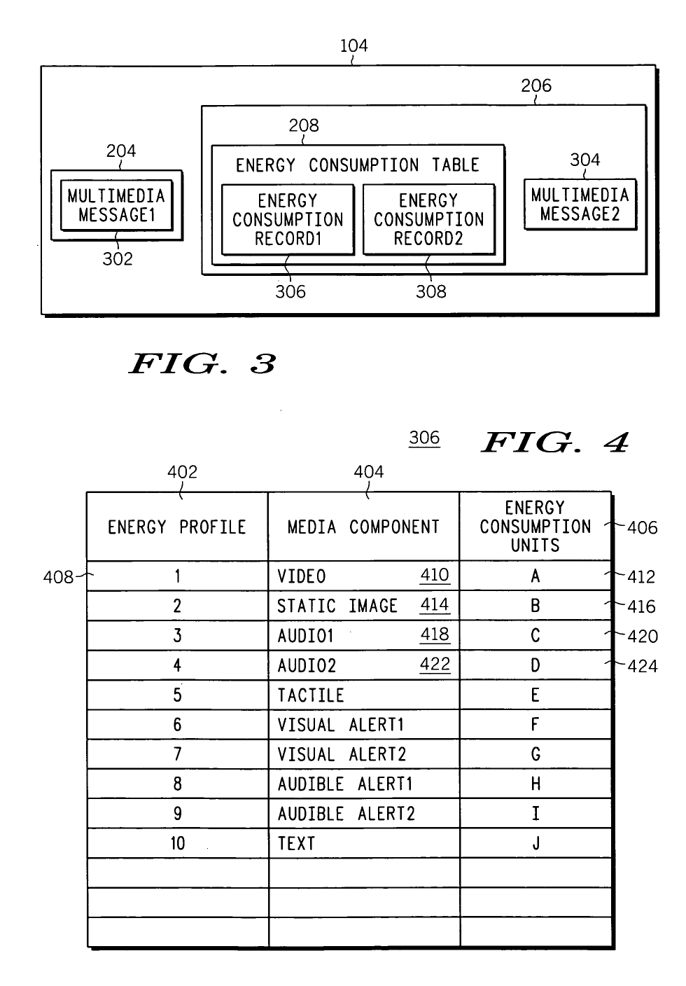

FIG. 3 illustrates an exemplary memory 204 and storage memory module 206 of the electronic device 104. The memory 204 comprises volatile memory, for example, Random Access Memory (RAM). However, it may comprise non-volatile memory such as battery backed-up RAM. In FIG. 3, a multimedia message1 302 received by the wireless device 104, resides in the memory 204 during playback of the multimedia message1 302. An exemplary multimedia message is created using the Synchronized Multimedia Integration Language (SMIL) and is communicated, for example, by using the MMS standard. Additionally, an exemplary multimedia message includes one or more media components. A media component comprises various data and attributes, for example, voice data, audio data, text data, image data, video data, device alert control data, or the like.

An exemplary embodiment of the storage memory module 206 comprises the energy consumption table 208 and an optional multimedia message2 304. An exemplary energy consumption table 208 keeps track of energy consumption units for each type of media component in a multimedia message 302, 304. For example, each type of multimedia component discussed above, consumes a specific amount of energy units when played on any given wireless device 104, 106.

Additionally, the energy consumption table 208 includes an energy consumption record 306, 308 for each multimedia message 302, 304 residing in the wireless device 104. For example, FIG. 3 illustrates an energy consumption record1 306 for multimedia message1 302 and an energy consumption record2 308 for multimedia message2 304. An exemplary energy consumption record will be discussed in greater detail below.

The optional multimedia message2 304, for example, is a multimedia message that has been received by the electronic device and saved in the storage memory module 206 for future playback, editing, forwarding, or the like. Additionally, the optional multimedia message2 304 may be saved in the storage memory module 206 until the electronic device 104 has enough power to safely play the multimedia message2 304.

FIG. 4 shows an exemplary energy consumption record1 306 according to an exemplary embodiment of the present invention. The energy consumption record1 306 comprises an optional energy profile field 402, an optional media component field 404 and an optional energy consumption unit field 406. The optional energy profile field 402 associates each media component entry and respective energy unit entry with an energy profile number. For example, the media component entry 410 and respective energy unit entry 412 correspond to an energy profile1 408. The energy profile1 408 identifies that the video media component of the multimedia message1 304 consumes A energy units from the energy source (not shown) of the wireless device 104. In an exemplary embodiment of the present invention, the energy consumption record1 302 is referred to by the device controller 202 when determining whether to inhibit playback of a multimedia message in accordance with the present invention.

As discussed above, a multimedia message may comprise various media components. Each media component consumes a specific number of energy units from the power source (not shown) of the wireless device 104. For example, as illustrated in FIG. 4, the multimedia message1 302 includes a static image such as a picture in entry 414 that consumes B energy units, as shown in the table entry 416.

Additionally, the multimedia message1 302 includes an audio1 media component in entry 418, for example an MP3 song that plays for the duration of the video component in entry 408 and consumes C energy units, as shown in entry 420. However, the multimedia message1 302 also includes an audio2 media component in entry 422, for example, a short duration MP3 song that consumes D energy units, as shown in entry 424, which may be less than the energy units consumed by the audio1 component in entry 418. In an exemplary embodiment of the present invention, each media component of a received multimedia message 302, 306 corresponds to a separate energy profile.

The energy profile information, for example, the type of media component and its corresponding amount of energy consumption units may be pre-stored in the electronic device 104, or may be part of the multimedia message1 302. If the electronic device 104 includes the energy profile information, the electronic device 104 utilizes this pre-stored information in performing operational sequences for determining whether to playback multimedia message components. If the energy profile information is included as part of a received multimedia message1 302, the device controller 202 extracts this energy profile information from, for example, a specific field of the multimedia message that includes the energy profile information. Alternative embodiments may use combinations of pre-stored energy profile information and multimedia message specifically coupled energy profile information, as will be obvious to those of ordinary skill in the art in view of the present discussion. For example, in one example, the wireless device 104 would default to using pre-stored energy profile information, unless a specific multimedia message includes message specific energy profile information. In such a case, the message specific energy profile information will be used by the device controller 202 instead of using the pre-stored energy profile information.

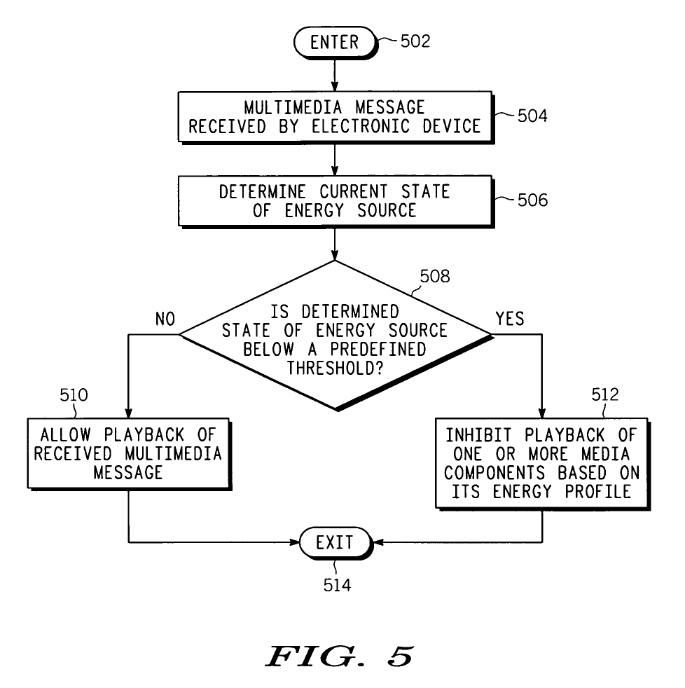

FIG. 5 is an operational flow diagram showing the overall process of one embodiment of the present invention. The operational flow diagram of FIG. 5 shows an overall process of how the wireless device 104, computer readable medium or any other electronic device, manages available power when a user requests playback of a multimedia message 302, 304. The operational flow diagram of FIG. 5 begins with step 502 and flows directly to step 504.

The wireless device 104, at step 504, receives a multimedia message. For example, a multimedia message 302, 304 may be received from the wireless communications network 102 or directly from another wireless device 106 through the local link 110. Once wireless device 104 receives the multimedia message 302, 304, at step 504, the device controller 202, at step 506, determines the current state of the energy source.

For example, in one embodiment of the present invention, the current state of the energy source may be determined by a method described in U.S. Pat. No. 5,115,182, the entire contents of which being hereby incorporated by reference. This method monitors the energy being consumed by each active device function and accumulates a measure of the energy consumed from the battery since the previous time the battery was charged. The remaining amount of available energy units yields the current state of the energy source of the electronic device 104. In an alternative embodiment of the present invention, the current state of the energy source of the electronic device 104 can be determined by measuring the voltage level of the energy source. The resulting measurement yields the current state of the energy source.

The device controller 202, at step 508, determines whether the determined state of the energy source of the electronic device 104 is below a predefined energy threshold. A predefined energy threshold may be, for example, a specific number or range of remaining energy units that are available for consumption or a specific voltage level or a range of voltage levels. Alternatively, a predefined threshold according to an embodiment of the present invention, may also correspond to a specific amount of recovery after a given load is applied to the device 104 for a duration of time. Some power management systems will load the battery or energy source and measure the voltage response to reach a predefined level. The amount of time to recovery is a measure of the remaining energy within the battery. The past history of usage of a user during a given time period between expected recharge may also be used as a threshold according to an embodiment of the present invention.

If the result of the determination at the above step 508 is negative the control flows to step 510. The device controller 202, at step 510, allows playback of all the media components of the multimedia message 302, 304. The control flow, at step 514, then exits. If the result of the determination at the above step 508 is positive, the control flows to step 512. The device controller 202, at step 512, inhibits playback of one or more media components of the received multimedia message 302, 304 based on the energy profiles of the media components.

The device controller 202, at step 512, places the electronic device 104 in a low power mode and the device controller 202 proceeds to examine the energy consumption units of each media component of the received multimedia message 302, 304. In one embodiment of the present invention, the device controller 202 locates the energy consumption record2 306, 308 in the energy consumption table 206 for the multimedia message1 302. Once the device controller 202 locates the energy records 306, 308, the device controller 202 processes the energy profiles located in the energy consumption records 306, 308 for each of the media components of the multimedia message1 302.

In an alternative embodiment of the present invention, the energy profiles of each media component can be included in the multimedia messages 302, 304 and the device controller 202 access the multimedia messages 302, 304 to determine the energy consumption units of each of the media components. The device controller 202 then compares the energy consumption units with an energy consumption threshold that is, for example, predefined for each media component.

If the number of energy consumption units for a particular media component exceeds the predefined energy consumption threshold, the device controller 202 inhibits playback of that particular media component. However, if the number of energy consumption units for a particular media component falls below the predefined energy consumption threshold, the device controller 202 allows the playback of that particular media component.

For example, playback of an audio media component may be inhibited if the required number of energy consumption units exceeds the predefined energy consumption threshold for the audio media component. However, even though playback of the audio media component may be inhibited, playback of a video media component, for example, may be allowed if the required number of energy consumption units falls below the predefined energy consumption threshold for the video media component. The control flow, at step 514, then exits.

Additionally, the device controller 202, at step 508, may determine whether the current state of the energy source is above or below multiple energy thresholds. For example, a first energy threshold may be defined to allow playback of media components requiring the greatest number of energy consumption units if the current state of the energy source exceeds the first energy threshold. A second energy threshold may be defined at a level below the first energy threshold allowing playback of a second most energy consuming media component.

In another embodiment of the present invention, playback of applications, files, and other device functions incorporating non-essential voice and/or data communications are also inhibited according to their energy profiles and the current state of the energy source, as discussed above. For example, playback of a stored MP3 file may be inhibited if the electronic device 104 enters a low power mode and the energy consumption units required by the MP3 file exceeds a predefined energy consumption threshold.

One of the advantages of inhibiting playback of a multimedia message, file, device function, or the like is that the power that would be consumed by one of the above items is conserved. The power conserved allows for essential functions such as voice communication to be prolonged when the energy source is low. An additional advantage of the present invention is that when playback of one media component of a multimedia message is inhibited, playback of another component may be allowed. Thus, various parts of the multimedia message can be viewed by the user.

In another embodiment of the present invention the device controller 202 performs the above steps 506, 508, 510, 512, as illustrated in FIG. 5, when a user requests playback of the multimedia message. In an alternative embodiment, the device controller 202 continuously performs the above steps 506, 508, 510, 512 shown in FIG. 5 at set intervals of time. If at a specific interval of time the determination at step 508 is negative, the device controller repeats the above steps 502, 504, 506, 508 at the next interval of time. The device controller 202 allows playback of the media components of the multimedia messages 302, 304 during this interval. However, if the determination at step 508 is positive, the process flows to step 512 and inhibits playback of the media components of each multimedia message 302, 304 in accordance with the above discussion until the current state of the energy source exceeds the predefined energy threshold.

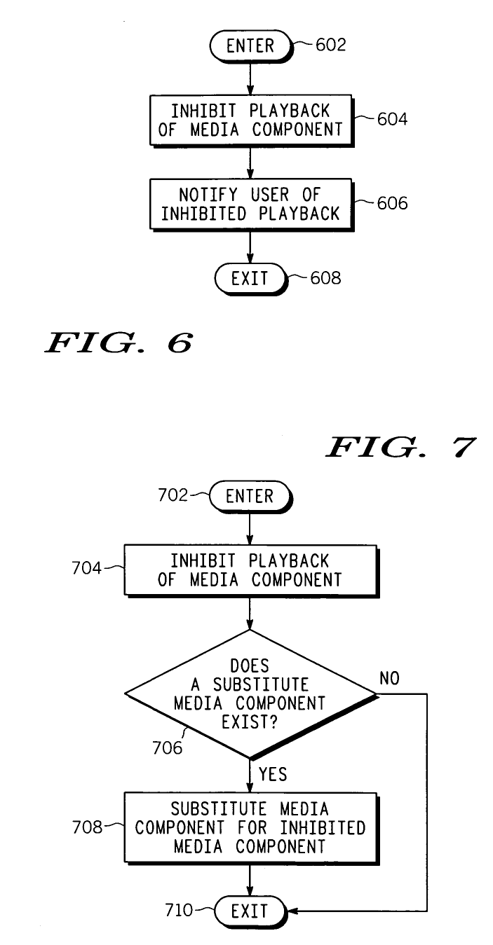

FIG. 6 is an operational flow diagram illustrating the process of notifying a user when playback of a media component of the multimedia messages 302, 304 is inhibited. The operational flow diagram of FIG. 6 begins with step 602 and flows directly to step 604. The device controller 202, at step 604, inhibits playback of one or more media components, as discussed above with reference to step 512 in FIG. 5.

The device controller 202, at step 606, notifies the user that playback of a media component of a multimedia message 302, 304 is inhibited. The notification may be given at the moment the device controller 202 inhibits playback of an item or when the user requests playback of the item. Once a user receives notification of the inhibited playback, the user may be given the option to manually allow playback of the inhibited media component.

In one embodiment of the present invention, the notification may be by audible, visual, tactile, or the like, indication. For example, an audible indication can include a beep or an audio clip indicating that playback of a media component of a multimedia message 302, 304 is inhibited. A visual indication may be, for example, text displayed on the screen indicating that playback of a media component of the multimedia message 302, 304 is inhibited. Also, the media component inhibited may also be hidden from the user as an indication of the inhibited playback. A tactile indication, for example, may include a silent vibratory signal provided to a user's body indicating that playback has been inhibited. Additionally, in wireless devices that use a multimedia center or inbox to list available multimedia messages and other forms of media, a strikethrough may be placed through a symbol representing the message or through a symbol representing the media to indicate that playback has been inhibited. The control flow, at step 608, then exits.

FIG. 7 is an operational diagram that describes another embodiment for inhibiting playback of one or more media components of a received multimedia message. The operational diagram of FIG. 7 shows an overall process for substituting a new media component for an inhibited media component. The operation flow diagram begins with step 702 and flows directly into step 704.

The device controller, at step 704, inhibits playback of one or more media components according to the present invention, as discussed above with reference to step 512 in FIG. 5. The device controller, at step 706, determines whether a new media component independent of the multimedia message can be substituted for the inhibited media component. If the result of this determination is negative, the control flows to step 710 and exits. If the result of this determination is positive, the control flows to step 708.

In one embodiment of the present invention, the device processes the energy profiles of new media components comparable to the inhibited media component to determine whether a substitute media component exists. For example, an energy profile record including the number of energy consumption units for the comparable media component may be included in the energy consumption table 208. The device controller 202 compares the number of required energy consumption units for the new media component with a predefined energy consumption threshold associated with the new media component. If the required number of energy units for new media component exceeds the threshold, the control flow, at step 710, then exits. However, if the number of required energy units falls below the threshold, a substitute media component exists.

The device controller 202, at step 708, substitutes the comparable media component for the inhibited media component of the received multimedia message1 302. For example, a received multimedia message may comprise an audio media component that requires playback through a loud speaker on the wireless device 104. If the wireless device 104 currently operates in a low power mode and the audio media component exceeds the associated threshold, the device 202 controller inhibits playback. However, the wireless device 104 may include a comparable media component, for example, playing the audio media component through the normal speaker. If the required number of energy consumption units for playing the audio component through the normal speaker falls below its threshold, the device controller 202, substitutes this media component for the inhibited audio media component. The control flow, at step 710 then exits.

The present invention can be realized in hardware, software, or a combination of hardware and software. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least a computer readable medium allowing a computer to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network that allow a computer to read such computer readable information.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method for dynamically managing available power for an electronic device based on energy units required by a multimedia message, the method comprising:
receiving a multimedia message, wherein at least one media component of the multimedia message corresponds to an energy profile;
determining a current state of an energy source of an electronic device; and
inhibiting playback of the at least one media component corresponding to the energy profile if the determined current state of the energy source is below a predefined energy threshold.

2. The method of claim 1, further comprising the steps of:
inhibiting playback of at least a first media component corresponding to at least a first energy profile if the determined current state of the energy source is below a predefined energy threshold; and
allowing playback of at least a second media component corresponding to at least a second energy profile, wherein the at least second energy profile is above a predefined energy consumption threshold.

3. The method according to claim 1, further comprising the steps of:
substituting an additional media component corresponding to an additional energy profile for the at least one media component when playback of the at least one media component is inhibited; and
allowing playback of the additional media component, wherein the additional energy profile is above a predefined energy consumption threshold.

4. The method according to claim 1, further comprising the steps of:
defining at least a first threshold, wherein playback of a first most energy consuming media component is allowed when the determined current state of the energy source is above the at least first energy threshold; and
defining at least a second threshold below the at least first threshold, wherein playback of a second most energy consuming media component is allowed when the determined current state of the energy source is above the at least second energy threshold and below the at least first energy threshold.

5. The method of claim 1, further comprising the steps of:
indicating to a user of the electronic device by an indicating means that playback of one or more of the media components of the multimedia message is inhibited.

6. The method of claim 1, wherein a user of the electronic device manually allows playback of the at least one media component.

7. An electronic device comprising:
an energy source;
a receiver for receiving wireless communications comprising at least one multimedia message including at least one media component corresponding to an energy profile;
a memory for storing the received multimedia message; and
a device controller electrically coupled to the memory, and wherein the device controller determining a current state of the energy source and inhibiting playback of the at least one media component if the current state of the energy source is below a predefined energy threshold.

8. The electronic device according to claim 6, wherein the at least one multimedia is a visual media component.

9. The electronic device according to claim 6, wherein the at least one multimedia component is an audio media component.

10. The electronic device according to claim 6, wherein the at least one multimedia component includes a textual media component.

11. The electronic device according to claim 6, wherein the at least one multimedia component is a tactile component.

12. A computer readable medium including computer instructions for dynamically managing available power for an electronic device based on energy units required by a multimedia message, the computer instructions comprising instructions for:
receiving a multimedia message, wherein at least one media component of the multimedia message corresponds to an energy profile;
determining a current state of an energy source of an electronic device; and
inhibiting playback of the at least one media component corresponding to the energy profile if the determined current state of the energy source is below a predefined energy threshold.

13. The computer readable medium of claim 12, further comprising instructions for:
inhibiting playback of at least a first media component corresponding to at least a first energy profile if the determined current state of the energy source is below a predefined energy threshold; and
allowing playback of at least a second media component corresponding to at least a second energy profile, wherein the at least second energy profile is within the predefined energy threshold.

14. The computer readable medium of claim 12, further comprising instructions for:
substituting an additional media component corresponding to an additional energy profile for the at least one media component when playback of the at least one media component is inhibited; and
allowing playback of the additional media component, wherein the additional energy profile is within a predefined energy consumption threshold.

15. The computer readable medium of claim 12, further comprising instructions for:
defining at least a first threshold, wherein playback of a first most energy consuming media component is allowed when the determined current state of the energy source is above the at least first energy threshold; and
defining at least a second threshold below the at least first threshold, wherein playback of a second most energy consuming media component is allowed when the determined current state of the energy source is above the at least second energy threshold and below the at least first energy threshold.

16. The computer readable medium of claim 12, further comprising instructions for:
indicating to a user of the electronic device by an indicating means that playback of one or more of the media components of the multimedia message is inhibited.

17. The computer readable medium of claim 12, wherein a user of the electronic device manually allows playback of the at least one media component.
